(19) United States
(12) Patent Application Publication
(10) Pub. No.: US 2023/0198362 A1
(43) Pub. Date: Jun. 22, 2023

(54) VIBRATION MOTOR AND ELECTRONIC DEVICE

(71) Applicant: NIDEC CORPORATION, Kyoto (JP)

(72) Inventors: Atsunori HIRATA, Kyoto (JP); Tomohiro KOBAYASHI, Kyoto (JP)

(21) Appl. No.: 18/068,521

(22) Filed: Dec. 20, 2022

(30) Foreign Application Priority Data
Dec. 21, 2021 (JP) 2021-206595

(51) Int. Cl. H02K 33/02; H02K 1/12; H02K 1/34

(52) U.S. Cl. CPC H02K 33/02; H02K 1/12; H02K 1/34

(57) ABSTRACT

A vibration motor includes a stator, a vibrator capable of vibrating in an axial direction, and an elastic member that connects the vibrator and the stator and is arranged on the axially upper side of the vibrator. The vibrator includes a mass body and a magnet member fixed to the mass body on the axially lower side of the mass body. The mass body includes a base portion extending in a radial direction and a column portion extending axially downward from the base portion. The magnet member has a hole portion recessed axially downward from an upper surface or penetrating through the magnet member. An outer edge of the hole portion is arranged radially outward of the column portion. The base portion faces an upper end of the coil in the axial direction.

### CROSS REFERENCE TO RELATED APPLICATIONS

The present invention claims priority under 35 U.S.C. §119 to Japanese Patent Application No. 2021-206595 filed on Dec. 21, 2021, the entire content of which is incorporated herein by reference.

### FIELD OF THE INVENTION

The present disclosure relates to a vibration motor and an electronic device.

### BACKGROUND

Conventionally, various apparatuses such as a smartphone and other portable devices include a vibration motor as a vibration generation device. The vibration motor is used for a function of notifying the user of an incoming call, an alarm, and the like, or a function of haptic feedback in a human interface, for example.

In general, a vibration motor includes a stator, an elastic member, and a vibrator. The stator includes a housing and a coil. The vibrator includes a magnet. The vibrator and the housing are connected by an elastic member. When the coil is energized to generate a magnetic field, the vibrator vibrates.

Conventionally, in a vibration motor, there has been a case where a mass body is used for the purpose of increasing the weight of a vibrator. However, depending on a structure of the vibration motor, there has been a problem that size of the mass body is limited, and vibration output is suppressed.

### SUMMARY

An exemplary vibration motor of the present disclosure includes a stator, a vibrator capable of vibrating in an axial direction, and an elastic member that connects the vibrator and the stator and is arranged on the axially upper side of the vibrator. The vibrator includes a mass body and a magnet member fixed to the mass body on the axially lower side of the mass body. The stator includes a coil formed by winding a conductive wire in a circumferential direction radially outward of the magnet member. The mass body includes a base portion extending in a radial direction and a column portion extending axially downward from the base portion. The magnet member has a hole portion recessed axially downward from an upper surface or penetrating through the magnet member. An outer edge of the hole portion is arranged radially outward of the column portion. The base portion faces an upper end of the coil in the axial direction.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view of a vibration motor according to an exemplary embodiment of the present disclosure;

FIG. 2 is a cross-sectional view taken along line A-A in FIG. 1;

FIG. 3 is a cross-sectional view illustrating a partial configuration of the vibration motor according to a first variation;

FIG. 4 is a cross-sectional view illustrating a partial configuration of the vibration motor according to a second variation;

FIG. 5 is a partially enlarged view of the configuration illustrated in FIG. 2; and

FIG. 6 is a schematic diagram illustrating an example of an electronic device.

### DETAILED DESCRIPTION

Hereinafter, exemplary embodiments of the present disclosure will be described with reference to the drawings. Note that, in the drawings, a direction along a center axis J of a vibration motor 100 is an axial direction, and the axially upper side, axially above, or axially upward is denoted by Z1 and the axially lower side, axially below, or axially downward is denoted by Z2. A direction orthogonal to the center axis J is referred to as radial direction, a direction approaching the center axis J is referred to as radially inward, and a direction away from the center axis J is referred to as radially outward. Further, a direction about the center axis J is referred to as circumferential direction. Note that each of the above directions does not limit a direction when the vibration motor is incorporated in a device.

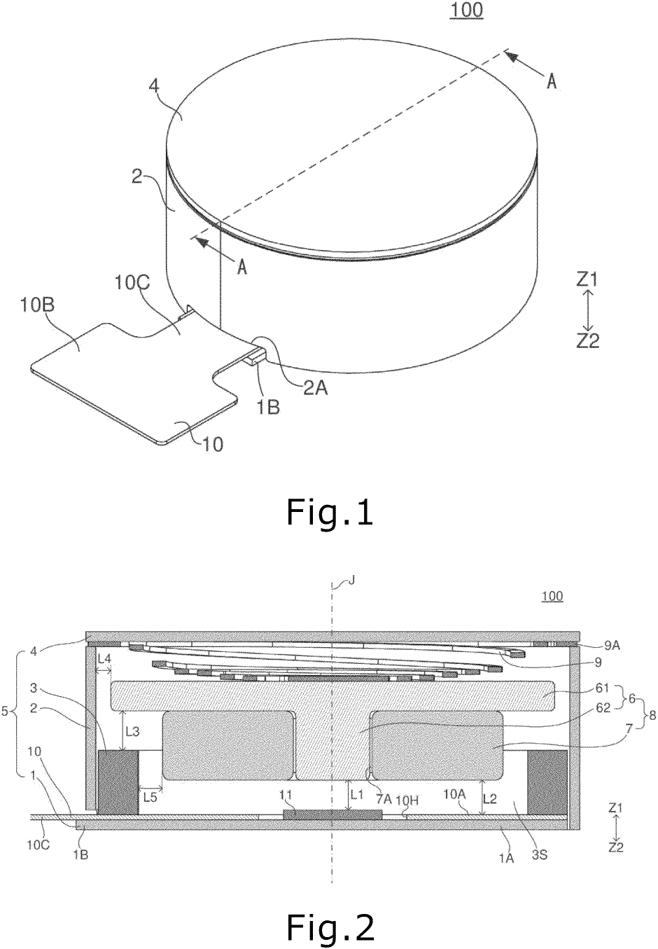

FIG. 1 is a perspective view of the vibration motor 100 according to an exemplary embodiment of the present disclosure. FIG. 2 is a cross-sectional view taken along line A-A in FIG. 1.

The vibration motor 100 includes a stator 5, a vibrator 8, an elastic member 9, and a cushioning material 11.

The stator 5 includes a base plate 1, a housing 2, a coil 3, a lid portion 4, and a substrate 10.

The base plate 1 is a plate-like member made from, for example, stainless steel, and includes a disc portion 1A as a main portion, and a protruding piece 1B (see FIG. 1) protruding radially outward in a rectangular shape from a part of an edge portion of the disc portion 1A.

The housing 2 has a cylindrical shape extending in the axial direction about the center axis J, and is made from, for example, stainless steel. A lower end portion of the housing 2 is arranged along an edge portion of the disc portion 1A. The housing 2 accommodates the vibrator 8, the elastic member 9, the coil 3, a first substrate portion 10A of the substrate 10 to be described later, and the cushioning material 11.

The substrate 10 is a flexible printed circuit (FPC), and includes the first substrate portion 10A having an annular shape, a second substrate portion 10B having a rectangular shape, and a connection substrate portion 10C that connects the first substrate portion 10A and the second substrate portion 10B in the radial direction. The first substrate portion 10A is arranged on an upper surface of the disc portion 1A and is fixed to the disc portion 1A by, for example, an adhesive. The protruding piece 1B protrudes outward from a notch portion 2A provided on a lower end portion of the housing 2 and notched axially upward (see FIG. 1). The connection substrate portion 10C is arranged on an upper surface of the protruding piece 1B and protrudes outward from the notch portion 2A. The second substrate portion 10B is arranged outside the housing 2. The second substrate portion 10B is provided with a second electrode portion (not illustrated). The first substrate portion 10A is electrically connected to the coil 3 described later. The substrate 10 is provided to supply current to the coil 3.

The coil 3 is configured by winding a conductive wire in the circumferential direction, and is arranged along an inner wall surface of the housing 2. The coil 3 is arranged on an upper surface of the first substrate portion 10A, and is fixed to the first substrate portion 10A by, for example, an adhesive.

A lead wire (not illustrated) of the coil 3 is connected to a first electrode portion (not illustrated) provided on the first substrate portion 10A by soldering. The first electrode portion is arranged in an internal space 3S surrounded by the coil 3 in the radial direction. That is, a connection point between the lead wire and the first electrode portion by soldering is arranged in the internal space 3S. Since the second electrode portion and the first electrode portion are connected by a wiring provided on the substrate 10, current can be supplied to the coil 3 via the second electrode portion.

The vibrator 8 is capable of vibrating in the axial direction, and includes a mass body 6 and a magnet member 7. That is, the vibration motor 100 includes the vibrator 8 capable of vibrating in the axial direction.

The mass body 6 is provided for the purpose of increasing the weight of the vibrator 8 to increase vibration output of the vibration motor 100. The mass body 6 is made from, for example, a tungsten alloy, and includes a base portion 61 and a column portion 62. The base portion 61 is formed in a disk shape expanding in the radial direction about the center axis J. However, the base portion 61 may be configured in, for example, a rectangular shape without limitation to a disk shape, and may be configured in a truncated cone shape whose diameter changes along the axial direction. Further, the base portion 61 may have a recessed portion or a protruding portion for attaching the magnet member 7 or the elastic member 9. That is, the mass body 6 has the base portion 61 expanding in the radial direction.

The column portion 62 extends axially downward in a columnar shape from a radially central portion of the base portion 61. That is, the mass body 6 has the column portion 62 extending axially downward from the base portion 61.

The magnet member 7 is one annular member around the center axis J, and has a hole portion 7A penetrating in the axial direction at a radial central portion. Note that the hole portion 7A is not limited to a through hole, and may be recessed axially downward from an upper surface of the magnet member 7. In this case, the axially lower side of the hole portion is covered with the magnet member 7. That is, the magnet member 7 has the hole portion 7A recessed axially downward from an upper surface or penetrating through the magnet member 7.

Note that the magnet member 7 is not limited to one member, and may be configured by a plurality of arc-shaped members arranged in the circumferential direction.

The magnet member 7 has an N pole and an S pole in the axial direction. That is, the magnet member 7 has an S pole axially upward and an N pole axially downward, or has an N pole axially upward and an S pole axially downward. Magnetization in the axial direction relatively facilitates magnetization.

The column portion 62 of the mass body 6 is inserted into the hole portion 7A of the magnet member 7 from the axially upper side. By the above, an outer edge of the hole portion 7A is arranged radially outward of the column portion 62. The hole portion 7A is fixed to the column portion 62 by an adhesive arranged in a gap between an outer edge of the hole portion 7A and the column portion 62. By the above, the magnet member 7 is arranged on a lower surface of the base portion 61 and fixed to the column portion 62. Note that the magnet member 7 may be fixed to the base portion 61 by an adhesive arranged in a gap between an upper surface of the magnet member 7 and a lower surface of the base portion 61. That is, the vibrator 8 includes the magnet member 7 fixed to the mass body 6 on the axially lower side of the mass body 6.

The elastic member 9 is configured as a cut-and-raised spring formed by being cut and raised from a plate-shaped material, and a diameter of the elastic member 9 increases toward the axially upper side. A lower end portion of the elastic member 9 is fixed to an upper surface of a radially central portion of the base portion 61 by welding, for example. An upper end portion of the elastic member 9 is fixed to the upper end of the housing 2 by welding, for example. By the above, the vibrator 8 is fixed to the housing 2 by the elastic member 9. Therefore, the vibrator 8 is supported so as to be able to vibrate in the axial direction with respect to the stator 5.

That is, the vibration motor 100 includes the vibrator 8 and the stator 5 connected to each other, and the elastic member 9 arranged on the axially upper side of the vibrator 8. Details of the elastic member 9 will be described later. Note that the configuration is not limited to the configuration illustrated in FIG. 2, and an elastic member different from the elastic member 9 may be arranged between the magnet member 7 and the substrate 10.

In a state where the vibrator 8 is fixed to the elastic member 9, the magnet member 7 is arranged radially inward of the coil 3 and faces the coil 3 in the radial direction. That is, the stator 5 includes the coil 3 formed by winding a conductive wire in the circumferential direction radially outward of the magnet member 7.

When current is supplied to the coil 3 via the substrate 10, a line of magnetic force is generated in the coil 3, and the vibrator 8 vibrates in the axial direction by interaction with a line of magnetic force by the magnet member 7. By the above, vibration is generated in the vibration motor 100.

A radially outer end portion of the base portion 61 faces the coil 3 in the axial direction on the axially upper side of the coil 3. That is, the base portion 61 faces the upper end of the coil 3 in the axial direction. As described above, in the present embodiment, since an axial length of the coil 3 is shortened and the mass body 6 is expanded to a position facing the coil 3 in the axial direction, the weight of the mass body 6 increases, and higher vibration output can be obtained.

The lid portion 4 is formed in a disk shape and is made from, for example, stainless steel. The lid portion 4 is fixed to an upper surface of an upper end portion of the elastic member 9 by welding, for example. By the above, the lid portion 4 suppresses intrusion of a foreign matter into the housing 2.

The coil 3 is fixed to an upper surface of the first substrate portion 10A of the substrate 10. That is, the vibration motor 100 includes the substrate 10 located further on the axially lower side than the coil 3. The first substrate portion 10A has a hole portion 10H having a circular shape penetrating in the axial direction about the center axis J. The cushioning material 11 is arranged inside the hole portion 10H and is fixed to an upper surface of the disc portion 1A of the base plate 1 with, for example, an adhesive. Part of the axially upper side of the cushioning material 11 is arranged in the internal space 3S surrounded in the radial direction by the coil 3.

The cushioning material 11 is arranged axially below the vibrator 8. The cushioning material 11 faces the entire lower surface of the column portion 62 of the mass body 6 in the axial direction, and faces a radially inner end portion of the magnet member 7 in the axial direction. That is, the vibration motor 100 includes the cushioning material 11 facing the vibrator 8 in the axial direction radially inward of the coil 3.

Here, as illustrated in FIG. 2, an axial distance L1 between an upper surface of the cushioning material 11 and a lower surface of the column portion 62 is smaller than an axial distance L2 between an upper surface of the first substrate portion 10A and a lower surface of the magnet member 7. In the configuration illustrated in FIG. 2, the column portion 62 does not protrude axially downward further than the magnet member 7. That is, a lower surface of the column portion 62 and a lower surface of the magnet member 7 are located at the same axial position. By the above, an axial distance between an upper surface of the cushioning material 11 and a lower surface of the column portion 62 and an axial distance between an upper surface of the cushioning material 11 and a lower surface of the magnet member 7 are the same axial distance L1. In other words, the axial distance L1 between the cushioning material 11 and the vibrator 8 is smaller than the axial distance L2 between the upper end of the substrate 10 and the vibrator 8.

By the above, for example, even if the vibrator 8 excessively moves to the substrate 10 side in a case where the vibration motor 100 is dropped, the vibrator 8 comes into contact with the cushioning material 11 before the vibrator 8 comes into contact with the substrate 10. Therefore, the substrate 10 and an element on the substrate 10 can be protected from the vibrator 8. For example, it is possible to protect a connection portion (not illustrated) by soldering between a lead wire of the coil 3 and the first electrode portion provided on the first substrate portion 10A.

Here, the connection portion may be provided on the radially inner side of a radially outer surface of the magnet member 7. At this time, an axial distance between the cushioning material 11 and the vibrator 8 may be smaller than an axial distance between the connection portion and the vibrator 8, and between a portion of the lead wire on the radially inner side of a radially outer surface of the magnet member 7 and the vibrator 8. By the above, the connection portion and the lead wire can be protected.

Further, the connection portion may be provided radially outside the magnet member 7. This makes it possible to prevent contact between the connection portion and the vibrator 8.

In the configuration illustrated in FIG. 2, in a case where the column portion 62 comes into contact with the cushioning material 11, the magnet member 7 also comes into contact with the cushioning material 11. However, size of the cushioning material 11 may be reduced so that the cushioning material 11 does not face the magnet member 7 in the axial direction. That is, the cushioning material 11 preferably faces at least the column portion 62 between the magnet member 7 and the column portion 62 in the axial direction. By the above, the impact applied to the magnet member 7 can be suppressed as compared with a case where the cushioning material 11 is in contact with only the magnet member 7. It is possible to suppress an adverse effect on the magnet member 7 due to collision with the cushioning material 11.

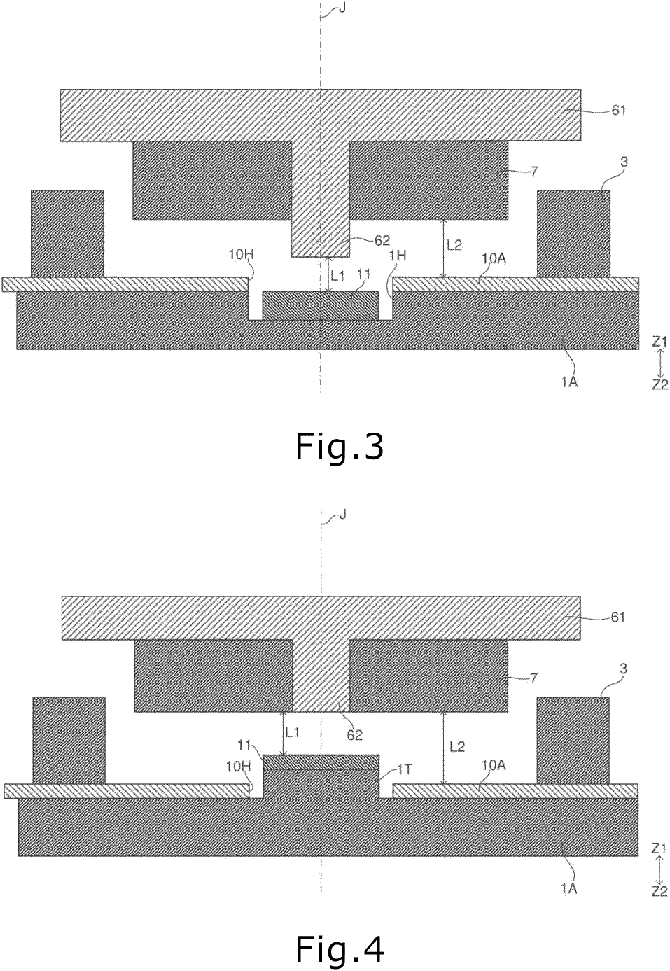

FIG. 3 is a cross-sectional view illustrating a partial configuration of the vibration motor 100 according to a first variation. In the configuration illustrated in FIG. 3, the column portion 62 protrudes axially downward further than the magnet member 7. Therefore, a lower surface of the column portion 62 is located axially below a lower surface of the magnet member 7. Further, in the configuration illustrated in FIG. 3, the disc portion 1A of the base plate 1 is provided with a recessed portion 1H having a cylindrical shape recessed axially downward. The recessed portion 1H is connected to the axially lower side of the hole portion 10H in the first substrate portion 10A. The cushioning material 11 is arranged in the recessed portion 1H. By the above, the cushioning material 11 is arranged axially below the coil 3. Therefore, the cushioning material 11 is not necessarily arranged in the internal space 3S as in the configuration illustrated in FIG. 2.

In such a configuration illustrated in FIG. 3, the axial distance L1 between the cushioning material 11 and the column portion 62 is smaller than the axial distance L2 between an upper surface of the first substrate portion 10A and the magnet member 7. This makes it possible to protect the first substrate portion 10A and an element on the first substrate portion 10A from the magnet member 7. Since the column portion 62 protrudes axially downward further than the magnet member 7, it is easy to shorten the axial distance L1.

FIG. 4 is a cross-sectional view illustrating a partial configuration of the vibration motor 100 according to a second variation. In the configuration illustrated in FIG. 4, a protruding portion 1T protruding axially upward in a columnar shape is provided on the disc portion 1A of the base plate 1. The protruding portion 1T is arranged inside the hole portion 10H in the first substrate portion 10A and protrudes axially upward from the hole portion 10H. The cushioning material 11 is fixed to an upper surface of the protruding portion 1T. Therefore, the cushioning material 11 is arranged further on the axially upper side than the first substrate portion 10A.

In such a configuration illustrated in FIG. 4, the axial distance L1 between the cushioning material 11 and the vibrator 8 is smaller than the axial distance L2 between an upper surface of the first substrate portion 10A and the magnet member 7. This makes it possible to protect the first substrate portion 10A and an element on the first substrate portion 10A from the magnet member 7. Since the cushioning material 11 is arranged axially above the first substrate portion 10A, the axial distance L1 can be easily shortened.

Note that the embodiments illustrated in FIGS. 2, 3, and 4 may be implemented in combination as appropriate. Further, the configuration may be such that only one of the configuration in which the column portion 62 protrudes axially downward further than the magnet member 7 and the configuration in which the recessed portion 1H having a columnar shape recessed axially downward is provided as illustrated in FIG. 3 is used and implemented.

As illustrated in FIG. 2, the axial distance L1 between the cushioning material 11 and the vibrator 8 is smaller than an axial distance L3 between the upper end of the coil 3 and the base portion 61. By the above, even if the vibrator 8 moves excessively to the substrate 10 side, it is possible to suppress contact between the base portion 61 and the coil 3. Therefore, the coil 3 can be protected from the mass body 6.

Further, the housing 2 corresponds to a side wall portion. That is, the stator 5 has the side wall portion 2 extending in the axial direction radially outward of the coil 3. A radial distance L4 between the base portion 61 and the side wall portion 2 is smaller than a radial distance L5 between the magnet member 7 and the coil 3. As a result, in a case where the vibrator 8 swings in the radial direction, the base portion 61 comes into contact with the side wall portion 2 before the magnet member 7 comes into contact with the coil 3. Therefore, the coil 3 can be protected from the magnet member 7.

Next, the elastic member 9 will be described more specifically. The elastic member 9 has a shape that increases in diameter toward the axially upper side. By the above, portions of the elastic member 9 do not come into contact with each other when the elastic member 9 is compressed. Therefore, a movable range of the vibrator 8 can be widened. Note that, in the configuration illustrated in FIG. 2, the elastic member 9 is formed of a cut-and-raised spring, but may be formed of a conical coil spring formed by winding a linear member in a conical shape.

Further, a radially outer end portion 9A in an upper end portion of the elastic member 9 faces the upper end of the coil 3 in the axial direction. By the above, the upper end portion of the elastic member 9 can be expanded in the radial direction to a position facing the coil 3. Therefore, it is possible to reduce stress by increasing an area of the elastic member 9 viewed in the vertical direction, and to improve the life of the elastic member 9.

Further, as illustrated in FIG. 2, the elastic member 9 is desirably fixed to only one of upper and lower end surfaces of the vibrator 8. By the above, the number of parts is reduced as compared with a configuration in which the vibrator 8 is supported on both upper and lower sides.

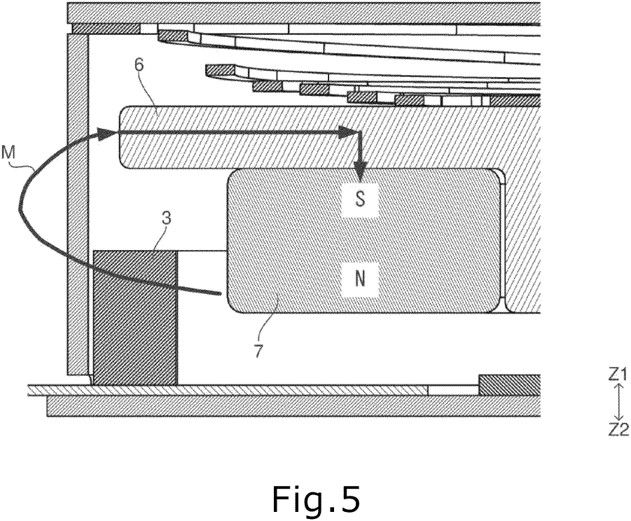

FIG. 5 is a partially enlarged view of the configuration illustrated in FIG. 2. The mass body 6 is made from a magnetic material. By the above, the mass body 6 serves as a yoke. A part of magnetic lines M exiting from an N pole of the magnet member 7 penetrates the coil 3 radially outward, passes through the mass body 6, and returns to an S pole of the magnet member 7. In a conventional configuration, there has been a possibility that driving forces cancel out each other as both of a magnetic line coming out from an N pole and a magnetic line returning to an S pole pass through a coil. On the other hand, in the present embodiment, it is possible to obtain higher vibration output by suppressing cancellation of driving forces.

The vibration motor 100 according to the above-described embodiment can be mounted on various electronic devices. By the above, an electronic device can be vibrated to realize functions such as notification to the operator or tactile feedback.

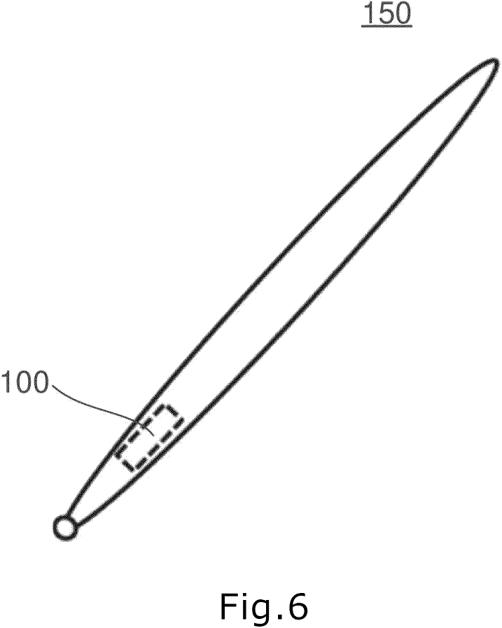

The vibration motor 100 can be mounted on, for example, an electronic device 150 schematically illustrated in FIG. 6. That is, the electronic device 150 includes the vibration motor 100. The electronic device 150 is a device that gives tactile stimulation to a person who operates the electronic device 150 by vibration of the vibration motor 100.

The electronic device 150 illustrated in FIG. 6 is, for example, a stylus pen. Since the vibration motor 100 outputs vibration according to setting, it is possible to give tactile feedback to the operator as if the operator is operating the electronic device 150 on paper, a blackboard, or the like even though the operator is operating the electronic device 150 in contact with a tablet device or the like.

Note that the electronic device is not limited to a stylus pen, and a smartphone, a tablet, a game device, a wearable terminal, and the like can also be employed.

In particular, since vibration output can be improved by the vibration motor 100 of the above-described embodiment, it is possible to effectively transmit vibration to the user of the electronic device 150.

The embodiment of the present disclosure is described above. Note that the scope of the present disclosure is not limited to the above embodiment. The present disclosure can be implemented by making various changes to the above-described embodiment without departing from the gist of the invention. The matters described in the above embodiment can be optionally combined together, as appropriate, as long as there is no inconsistency.

The technique of the present disclosure can be used for a vibration motor mounted on various devices, for example.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A vibration motor comprising:
a stator;
a vibrator capable of vibrating in an axial direction; and
an elastic member that connects the vibrator and the stator and is arranged on an axially upper side of the vibrator, wherein
the vibrator includes:
a mass body; and
a magnet member fixed to the mass body on an axially lower side of the mass body,
the stator includes a coil formed by winding a conductive wire in a circumferential direction on a radially outward of the magnet member,
the mass body includes:
a base portion extending in a radial direction; and
a column portion extending axially downward from the base portion,
the magnet member has a hole portion recessed axially downward from an upper surface or penetrating therethrough,
an outer edge of the hole portion is arranged radially outward of the column portion, and
the base portion faces an upper end of the coil in the axial direction.

2. The vibration motor according to claim 1, further comprising:
a substrate located axially below the coil; and
a cushioning material facing the vibrator in the axial direction on a radially inward of the coil, wherein
an axial distance between the cushioning material and the vibrator is smaller than an axial distance between an upper end of the substrate and the vibrator inside a radially outer surface of the magnet member.

3. The vibration motor according to claim 2, wherein
the cushioning material faces at least the column portion between the magnet member and the column portion in the axial direction.

4. The vibration motor according to claim 2, wherein
an axial distance between the cushioning material and the vibrator is smaller than an axial distance between an upper end of the coil and the base portion.

5. The vibration motor according to claim 1, wherein
the stator further includes a side wall portion extending in the axial direction radially outward of the coil, and
a radial distance between the base portion and the side wall portion is smaller than a radial distance between the magnet member and the coil.

6. The vibration motor according to claim 1, wherein
the elastic member has a shape that increases in diameter toward an axially upper side.

7. The vibration motor according to claim 6, wherein
a radially outer end portion in an upper end portion of the elastic member faces an upper end of the coil in the axial direction.

8. The vibration motor according to claim 1, wherein the mass body is made from a magnetic material.

9. The vibration motor according to claim 1, wherein
the magnet member has an N pole and an S pole in the axial direction.

10. An electronic device comprising the vibration motor according to claim 1.
